(19) United States
(12) Patent Application Publication
(10) Pub. No.: US 2002/0107959 A1
(43) Pub. Date: Aug. 8, 2002

(54) Customization of decision-tree based control process

(75) Inventor: Yevgeniy Shteyn, Cupertino, CA (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/777,505

(22) Filed: Feb. 5, 2001

(51) Int. Cl. G06F 15/16; G06F 15/173

(52) U.S. Cl. 709/225; 709/203

(57) ABSTRACT

A data processing system comprises at least a client, a control process unit and a customization unit. The control process unit is configured to execute a control process that enables access to the system from the client. The control process is based on a decision-tree. The decision-tree is comprised of inter-linked decision nodes. The customization unit is coupled to the control process unit. The customization unit determines from user-information a user entry decision-node and the customization unit configures the control process to enable the user to access the system from the client at the user entry decision-node.

### FIELD OF THE INVENTION

The invention generally relates to a method of customizing a decision-tree based control process that enables access to a data processing system from one of a plurality of clients.

The invention also relates to a data processing system to which access is enabled by a customizable decision-tree based control process.

The invention also relates to a device for accessing a data processing system.

The invention further relates to a computer readable storage medium for storing instructions for carrying out such a method.

### BACKGROUND ART

A variety of control processes provide users with access to data processing systems such as order processing system, information request services, customer support system, banking systems, home automation systems, etc. . . .

In order to request a data processing operation or a number of operations provided by a data processing system, a user needs to follow an access control process. Such a process may comprise going through a number of steps and logical rules associated with the steps. The control process is configured so that the data processing system performs the required operations in a consistent manner for every user.

In some cases, user-access to the data processing system is enabled by a decision-tree based control process. A decision-tree based process comprises several inter-linked decision nodes. When a user wants to reach a specific decision node associated with the data operation in which he/she is interested, the user may first have to traverse a number of preceding decision nodes. At these nodes the user can be required to make choices or provide additional information thereby enabling to progressively determine the path that leads to the appropriate node associated with the desired operation. These nodes often appear to the user as a series of interfaces such as graphical menus, buttons or voice prompts. For each node a choice has to be made or information has to be provided in order to retrieve the appropriate next menu associated with the next node.

Traversing these decision nodes is often perceived by users as an unnecessary burden. This is especially true for users who access the system for the same operation on a regular basis. In such case, the user is repeatedly asked to make the same choices or to provide the same information before reaching the specific node associated with the desired operation.

U.S. Pat. No. 5,465,358 gives a first possible approach to reducing the annoyance of the user desiring to access a data processing system. In a method disclosed in this document, data processing stimulus events are identified and stored in a database. Each sequence of user inputs which occurs in response to a subsequent occurrence of the identified stimulus event is also stored in the database. Upon subsequent recognition of a stimulus event, one or more selected sequences of user inputs are identified and displayed, along with and indicated probability of a user executing each identified sequence of user inputs. Thereafter, in response to a user input, a selected one of the identified sequences of user inputs may be automatically initiated, thereby enhancing a user's efficiency in performing a sequence of inputs within said data processing system.

### SUMMARY OF THE INVENTION

The inventor has realized that the user is overloaded with requests for information and decisions to make and that no advantage is taken of user-related information known to the data processing system. The approach given in U.S. Pat. No. 5,465,358 is only one feasible solution based on past user inputs.

It is an object of the invention to provide an alternative solution to this problem.

It is another object of the invention to provide a method of customizing an access control process to a data processing system, which enables an easy and fast user access to desired operations in a data processing system.

To this end, a method of the invention comprises defining the control process, the decision-tree is comprised of inter-linked decision-nodes;

retrieving user-information associated with a user seeking access to the data processing system;

determining, from the user-information, a user entry decision-node; and,

configuring the control process to enable the user to access the system from the client at the user entry decision-node.

Such a method provides user-customized access to the data processing system. The control process enables the user to be automatically lead to the entry decision-node thereby allowing bypassing other preceding nodes. An advantage of such control process is to be less burdensome for the user.

In an embodiment of the invention, the present customizing method comprises a step of identifying the user. Therefrom, access to the data processing system can be secured to prevent hackers from fraudulently using other users' related information and thereby forcing the customization of the control process to bypass certain decision nodes.

The invention further relates to a data processing system comprising a client, a control process unit and a customization unit. The control process unit is configured to execute a decision-tree based control process that enables access to the system from the client. The decision-tree is comprised of decision nodes. The customization unit is coupled to the control process unit. The customization unit is configured to determine a user entry decision-node from user-information that is associated with a user seeking access to the system, and to configure the control process to enable the user to access the system from the client at the user entry-node.

Such a system may comprise a memory component for storing the user-information. In another embodiment the user provides the user-information.

### BRIEF DESCRIPTION OF THE DRAWINGS

The invention is explained in further detail, by way of example, and with reference to the accompanying drawing wherein:

FIG. 1 and FIG. 3 are block diagrams of systems of the invention;

FIG. 2 and FIG. 4 are representations of decision-tree configurations of control processes enabling access to systems of the invention.

Elements within the drawing having similar or corresponding features are identified by like reference numerals.

### Preferred Embodiment

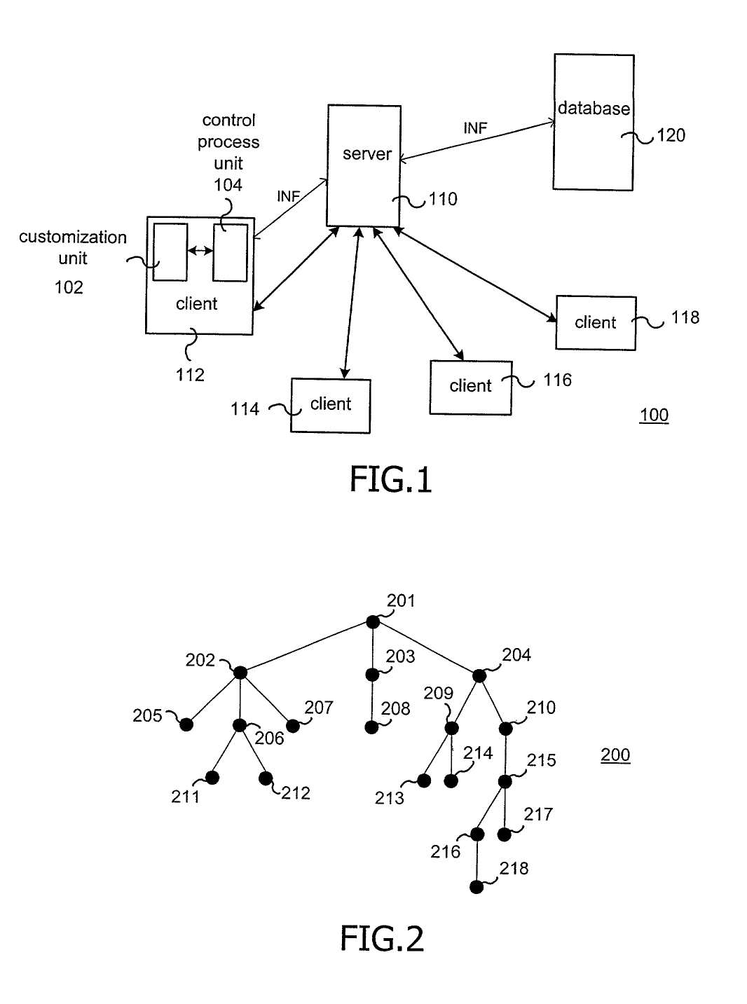

FIG. 1 is a data processing system 100 of the invention. The system 100 comprises a server 110 and a plurality of clients 112, 114, 116 and 118. The system 100 includes a database 120. One may also contemplate an embodiment of a system 100 in which the clients 112-118 are components of the server 110. For example, the clients 112-118 and the server 110 are implemented as separate software applications running on the same physical computer.

The server 110 is possibly a distributed server, which comprises a plurality of servers located and distributed at different locations thereby allowing resources spreading and optimization. The system 100 may form a client-server configuration or may form a distributed network such as a HAVI (Home Audio Video Interoperability) network, a JINI network, a CORBA (Common Object Request Broker Architecture) network or a uPnP (Universal Plug and Play) network, etc. . . . HAVI, JINI, CORBA, uPnP and other network infrastructures not mentioned here, define infrastructures and protocols that allow connectivity among devices in the network. These infrastructures have been developed by industry consortiums and standards organizations to allow data exchange, interaction and communication between networked programs and networked devices.

In the embodiment of FIG. 1, the clients 112-118 are control objects that permit the user to access the server 110 of the system 100 and to control the system 100 to perform data operations. A method of the invention comprises customizing the control process that enables access to the system 100 from one of the clients 112-118. For example, the client 112 comprises a control process unit 104 that runs the control process that enables access to the system 100. The client 112 further comprises a customization unit 102 coupled to the control process unit 104 and that allows customizing the control process run in the unit 102 as will be shown hereinafter. However units 102 and 104 may also be implemented in the server 110.

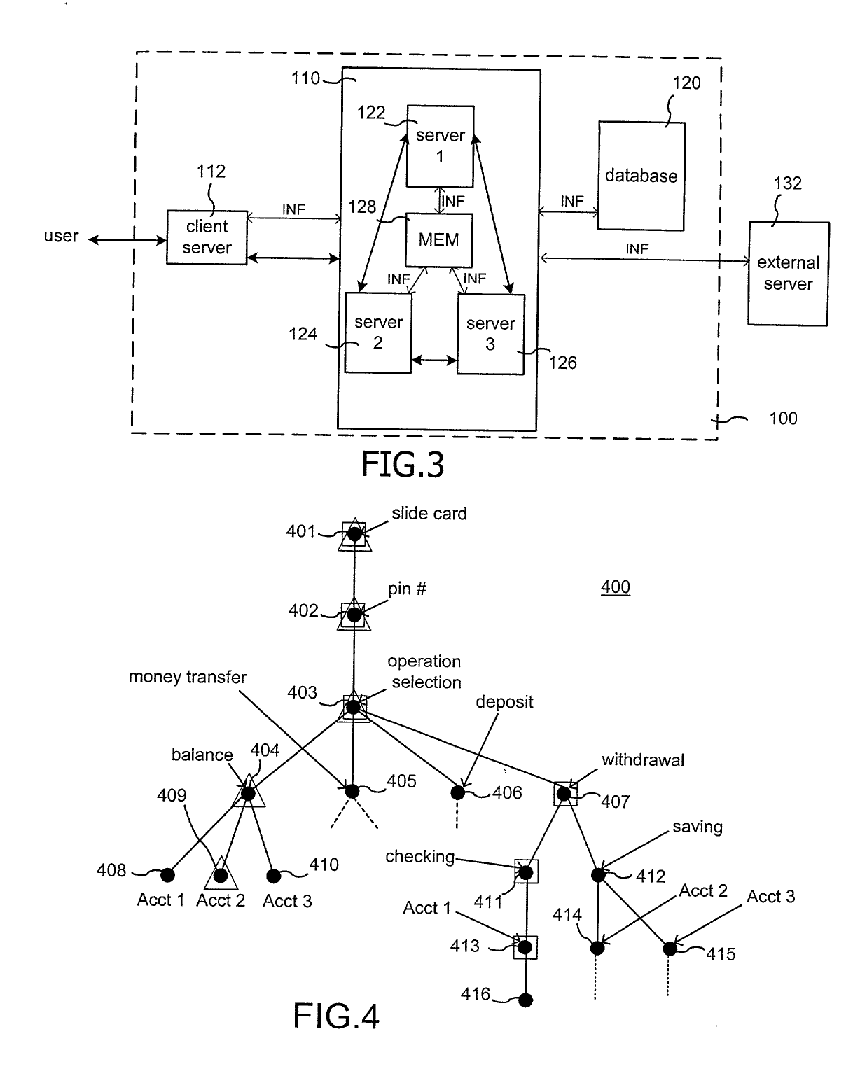

In this embodiment, the control process carried out in one of the clients 112-118 and which enables access to the system 100, is decision-tree configured. An example of such a decision tree 200 is given in FIG. 2. The decision-tree 200 comprises a plurality of inter-linked decision nodes 201-218. When the control process is activated, the system 100 leads the user from a first inter-linked node to another one until the decision node associated with the desired data operation is reached. In order for the system 100 to determine the next node and lead the user to it, user input might be required at some nodes. User input includes information that the user provides and/or selection by the user of an element from a list of proposed elements. Other nodes may be associated with data operations that the system 100 can execute. For example, these nodes may correspond to the confirmation and rendering of the results of the execution of a requested operation. This decision-tree configuration predefines a plurality of possible access paths to the system 100. These paths may start at node 201. For example, if the user wants the system 100 to perform the operation associated with node 217, the user may follow the path {201, 204, 210, 215, 217}. In the same way, if the user wants the system to perform the operation associated with node 205, the user may follow the path {201, 202, 205}. The execution of the decision tree based control process may be distributed among the clients 112-118 and the server 110.

In a method of the invention, user-information INF, associated with the user seeking access to the system 100, is determined. Information INF may be private information of the user, e.g. phone number, social security number, date of birth, bank account numbers, etc. . . . Information INF may also represent user preferences, e.g. preferred timeframe for a certain activity, preferred external security conditions, preferences in terms of operations that the system 100 is capable of performing, etc. . . . Information INF is any sort of user related information. Based on information INF, access to the system 100 is customized for the convenience of the user. In the embodiment of FIG. 1, information INF is stored in database 120 and supplied to the server 110 and in this embodiment, information INF is thereafter supplied to the customization unit 102. The customization unit 102 determines a user entry decision-node and configures the control process unit 104 to enable the user to access the system 100 directly from the determined user entry decision-node. The user may have entered information INF onto the system 100 during a setup session or information INF may be derived from a profile of the user built up from previous accesses to the system 100.

In another embodiment, the user may directly provide information INF when accessing the system 100. For example, the user carries a smart card or a RF identification label where information INF is stored and one of the clients 112-118 is equipped with a smart card reader. Thus, upon user identification, the system 100 retrieves relevant information INF from the smart card inserted in the reader. Alternatively, information INF is provided by a third party external to the system 100. Another example would be an ATM deposit envelope with a smart label on it, e.g. a bar code. The smart label contains information INF that is sufficient so that when the envelope is inserted, the control process is automatically configured to perform the check deposit operation. The user is not necessarily identified. The label may be provided by the bank of may be printed at home from a service offered on-line.

A method of the invention of customizing access to the system 100 is illustrated by way of FIG. 3 and FIG. 4. FIG. 3 gives an embodiment of the system 100. The system 100 comprises a distributed server 110 of a financial institution and the client 112. The client 112 is a public cash withdrawal machine or an ATM machine. The server 110 comprises a plurality of servers 122, 124 and 126 accessible from at least the client 112. The servers 122, 124 and 126 may be accessible from other types of clients, e.g. a PC, a PDA or a mobile phone. The server 110 may receive information INF from an internal memory 128 of the server 110, from the external database 120, from an external server 132 such as that of a credit organization and/or from the user himself.

FIG. 4 is a decision-tree 400 defining the access control process enabling access to the system 100 from the client 112. The decision tree 400 comprises at least decision nodes 401-416.

The access process to the system 100 from a given client may follow a decision-tree peculiar to the client. For example, access to the system 100 from client 112 may follow a different decision tree configuration than that from another client. This is partly due to the fact that modern information systems enable user access through multiple types of access devices or clients 112-118. These multiple types differ in their technical characteristics, location, security, information storage and processing capabilities, and as a result offer various user interfaces. For example, the display screen of a cellular phone is much smaller than that of a PC and therefore interactivity offered by mobile phones to users differ from interactivity offered by PCs.

When accessing the system 100, the user is first required at node 401 to slide a credit card. Once the user has slid the card, the system 100 leads the user to node 402 where the user is asked for a pin number associated with the card. If the entered pin number is the correct one, the system 100 leads the user to node 403. Nodes 401 and 402 correspond to a user identification sub-process. At node 403, the user is provided with a selection of four operations that the system 100 can execute: “balance” (checking the balance of an account), “money transfer” (transferring money from one account to another), “deposit” (deposing checks or cash on an account) or “withdrawal” (withdrawing money from an account). The user selects one of the four operations and is lead to node 404-407 respectively associated with the selected operation. Thus, if the user selects the “balance” operation, the system 100 leads the user to node 404. At node 404, the user is presented references of three accounts for which the balance can be shown. The user selects one of the three accounts and is then lead to node 408, 409 or 410 depending on the selected account reference. At node 408, 409 or 410, the system provides the user with the balance of the account.

In a method of the invention, accessing the system 100 from the client 112 is customized on the basis of information INF. Information INF is used to determine a path along the decision tree 400 from node 403 to an entry node. Then, once the user is identified, information INF is retrieved based on the user identification. The control process is then configured to enable the user to access the system 100 directly from the entry node. Hence, the user may customize the access control process. The user may have entered information INF and indicated in advance all decisions and other relevant information that the system 100 will use in order to automatically traverse a number of decision nodes.

FIG. 4 depicts two different access paths 1 and 2 along the decision tree 400 determined from two sets of user-related information INF1 and INF2. Information INF1 and INF2 may be both stored onto the system 100 and may be used alternately, e.g. under the user's control. The user may thus define a list of favorite paths leading to the entry nodes associated with the desired operations. When accessing the data processing system 100 the user can choose among the list.

Path 1 is {401, 402, 403, 404, 409} and is depicted by triangles. The entry node determined from information INF1 is node 409. Information INF1 comprises data “balance” and “account 2”. First, the user is identified by sliding the card and entering the correct pin number at nodes 401 and 402. Then, the client 112 or the server 110 retrieves information INF1. From information INF1, the system 100 determines the furthest decision node in the decision-tree 400 of the control process to which the user can be lead. From data “balance” and “account 2”, the system 100 has enough information available to fulfill the requirements of nodes 403 and 404. The control process is configured to enable the user to access the system at node 409. As a result, the system 100 automatically traverses nodes 403 and 404, and directly leads the user to entry node 409. As far as the user is concerned, it appears as if nodes 403 and 404 have been bypassed.

Path 2 is {401, 402, 404, 407, 411, 413} and is depicted by squares. The entry node determined from information INF2 is node 413. Information INF2 comprises data “withdrawal” and “account 1”. From information INF2 the system 100 has enough information available to automatically traverse nodes 403, 407 and 411. Node 413 requires the user to enter an amount of money to be withdrawn. Since the system 100 can not find such information from information INF2, the system 100 cannot lead the user further than node 413 in the control process. Both paths 1 and 2 include the user identification subprocess of nodes 401 and 402. The user may at any time modify information INF1 and INF2.

The access process can be further customized with regards to non user related criteria: UI capabilities, security, information storage of the client or the system, physical location of the client and environment of the client. For example, at night the access process may be further customized and accelerated for security purposes. For example, a security process may start running on top of the user-customized control process during a given time slot of the day. Thus, under predefined special circumstances, the control process is further customized based on these criteria in addition to the existing user-based customization.

Moreover, if information INF contains data 1 and data 2, data 1 may be indicated as having a higher priority over data 2 in case of conflict for example. Thus, when customizing the access process on the basis of information INF, the system 100 considers data 1 before considering data 2 and, in some cases, the system 100 ignores data 2 and takes into consideration data 1 only. For example, information INF may comprise specific data requesting that the system 100 always interrupts the customization at a given node specified by the user or the process. The user is thus directed to the node that is specified in information INF. For example, INF3 may comprise, in addition to data “balance” and “account 2” of information INF1, data “stop at balance” requesting the system 100 to interrupt the customization of the access process when node 404 is reached. In this case, the user is lead to node 404 where the user can input account 1's reference. In this case, the customization process is overwritten by the user input at node 404. The system 100 leads the user to node 408 associated with account 1 thereby ignoring data “account 2” of information INF3.

In another embodiment, the user may not be entitled to access the entire decision tree. Indeed part of the decision tree may be restricted to some authorized users. For example, some operations provided by the system 100 may be restricted to some authorized users. Access to these operations may require to traverse an identification decision node before accessing the decision nodes associated with these operations. Therefore, even if information INF may enable the system 100 to lead the user to a node beyond this identification decision node, the customization process is interrupted at this identification decision node. The user is initially stopped at the identification decision node for further identification verification. Once the user is identified as an authorized user at the identification node, the customization is pursued based on information INF. The system 100 then leads the user further in the decision tree to the entry node. The customization may be interrupted in this way for the system 100 running a security process on top of the customization of the control process. This may lead to a conditional customization of the control process.

The system 100 permits user interaction via clients offering different UIs (User Interface). A UI can be a display screen, a touch-sensitive screen, a keyboard, a light pen, a mouse, a software application, etc. . . . The prominent type of UI is a graphical user interface (GUI) that comprises GUI elements. GUI elements may be windows, pull-down menus, buttons, scroll bars, icons, wizards and interactive text. A GUI may also integrate multimedia elements such as e.g. voice or sound recognition elements and virtual reality interface elements.

In this embodiment, each decision node 401-414 corresponds to a GUI presented to the user. For example, node 401 corresponds to a GUI requesting the user to slide a card. GUI associated with node 402 requests the user to enter the pin number. GUI displayed for node 403 presents the four possible operations by means of four GUI elements, each GUI element being associated with one operation and so on.

GUI associated with a specific node may be customized using information INF. For example, information INF4 may comprise “balance” and “not account 1”. From information INF4, the system 100 leads the user to entry node 404. GUI associated to entry node 404 may be customized using information INF4. Before customization, GUI of entry node 404 includes three GUI elements: a first one for account 1, a second one for account 2 and a third one for account 3. Since information INF4 includes “not account 1”, GUI of node 404 may be customized by presenting only the two GUI elements associated with account 2 and 3. GUI of node 404 no longer comprises, after customization, GUI element for account 1.

Furthermore, GUI associated with entry node 404 may be customized to include a GUI element permitting the user to go back to the preceding inter-linked node thereby offering a greater flexibility in the customization.

It is to be noted that, with respect to the described method, modifications or improvements may be proposed without departing from the scope of the invention. For instance, it is clear that this method may be implemented in several manners, such as by means of wired electronic circuits or, alternatively, by means of a set of instructions stored in a computer-readable medium, said instructions replacing at least a part of said circuits and being executable under the control of a computer or a digital processor in order to carry out the same functions as fulfilled in said replaced circuits. The invention is thus not limited to the examples provided.

The word “comprising” does not exclude the presence of other elements or steps than those listed in a claim.

What is claimed is:

1. Method of customizing a decision-tree based control process that enables access to a data processing system from one of a plurality of clients, the method comprising:
defining the decision-tree based control process, the decision tree being comprised of inter-linked decision nodes;
retrieving user-information associated with a user seeking access to the system;
determining, from the user-information, a user entry decision-node; and,
configuring the control process to enable the user to access the system from the client at the user entry decision-node.

2. The method of claim 1, further comprising:
identifying the user.

3. The method of claim 1, wherein the user selects the user entry decision-node.

4. The method of claim 1, further comprising:
executing a security process for temporarily interrupting the customization of the control process.

5. The method of claim 1, further comprising:
determining the user entry decision-node on the basis of a physical environment of the client.

6. The method of claim 1, further comprising:
enabling the user to go from the entry decision-node to a preceding decision-node.

7. The method of claim 1, wherein the user-information is retrieved from the system.

8. The method of claim 1, wherein the user-information is retrieved from another party.

9. The method of claim 1, wherein the user supplies the user-information.

10. The method of claim 1, wherein the user-information is based on past behavior of the user.

11. The method of claim 1, wherein a decision node is associated with voice prompts.

12. The method of claims 1, wherein a decision node is associated with a displayed element.

13. The method of claim 1, further comprising:
displaying a graphical user interface associated with the user entry decision-node;
customizing the graphical user interface from the user-information.

14. The method of claim 13, further comprising:
enabling the user to customize the graphical user interface.

15. A data processing system comprising:
a client;
a control process unit to execute a decision-tree based control process that enables access to the system from the client, the decision-tree being comprised of inter-linked decision-nodes;
a customization unit coupled to the control process unit to determine a user entry decision-node from user-information associated with a user seeking access to the system, and to configure the control process to enable the user to access the system from the client at the user entry decision-node.

16. The system of claim 15, further comprising:
a memory unit for storing the user-information.

17. A computer readable storage medium for storing instructions for carrying out a method of customizing a decision-tree based control process that enables access to a data processing system from one of a plurality of clients, the method comprising:
defining the decision-tree based control process, the decision tree being comprised of inter-linked decision-nodes;
retrieving user-information associated to a user seeking access to the system;
determining from the user-information a user entry decision-node; and,
configuring the control process to enable the user to access the system from the client at the user entry decision-node.

18. A device for accessing a data processing system, the device comprising:
a control process unit to execute a decision-tree based control process that enables access to the system from the device, the decision-tree being comprised of inter-linked decision-nodes;
a customization unit coupled to the control process unit to determine a user entry decision-node from user-information associated with a user seeking access to the system, and to configure the control process to enable the user to access the system from the client at the user entry decision-node.
